(19) United States
(12) Patent Application Publication
(10) Pub. No.: US 2015/0282689 A1
(43) Pub. Date: Oct. 8, 2015

(54) MOP BUCKET

(71) Applicant: E.D. OATES PTY LTD, BROADMEADOWS (AU)

(72) Inventors: Frankie Ngan, Broadmeadows (AU); Karl Radolovic, Broadmeadows (AU)

(73) Assignee: E.D. OATES PTY LTD, BROADMEADOWS (AU)

(21) Appl. No.: 14/420,301

(22) PCT Filed: Aug. 8, 2013
(86) PCT No.: PCT/AU2013/000875

§ 371 Date: Feb. 6, 2015

(30) Foreign Application Priority Data
Aug. 8, 2012 (AU) 2012903415

(51) Int. Cl. A47L 13/58; A47J 47/18

(52) U.S. Cl. CPC A47L 13/58; A47J 47/18

(57) ABSTRACT

The present invention relates to a mop bucket (10) that comprises a floor (26) and side walls (22, 24) that project upwardly from the floor (26). The floor (26) and side walls (22,24) define an interior volume (28). The floor (26) opens into a cavity (32) that is provided in the interior volume (28). A wringer (50) can be suitably attached to the bucket (50) either within or above the interior volume (28). The cavity is suitably shaped to allow a wringer from a like mop bucket to be located in the cavity (32) when the like bucket is stacked on top of the mop bucket (10). This allows mop buckets to be easily stacked one on top of the other, in a space-efficient manner with the wringer attached.

### FIELD OF THE INVENTION

The present invention relates to a mop bucket. More particularly, the present invention relates to a mop bucket with an attachable wringer.

### BACKGROUND OF THE INVENTION

Any discussion of documents, acts, materials, devices, articles and the like in this specification is included solely for the purpose of providing a context for the present invention. It is not suggested or represented that any of these matters formed part of the prior art base or were common general knowledge in the field relevant to the present invention as it existed in Australia or elsewhere before the priority date of each claim of this application.

Mop buckets are composed of a receptacle and a wringing apparatus which is used to wring out the head of a mop that is placed within the receptacle. Wringing apparatus come in two broad categories: those that require manual operation (such as the familiar foot-activated roller assembly); and those that can be operated solely through manipulation of the mop.

Australian patent specification AU 2007302322 is an example of the second category, describing a wringing apparatus comprising a plurality of flexible v-shaped wall members, each with an inner and an outer leg and an interposed spacer. The wringing apparatus is operated by pressing the mop within the interior of the wall members.

While the product described in AU 2007302322 is thought to function well in practice, it is a somewhat bulky construction that is difficult to efficiently transport and display.

### SUMMARY OF THE INVENTION

According to a first aspect of the present invention there is provided a mop bucket comprising: a floor and side walls projecting upwardly from the floor, the floor and side walls defining an interior volume, the floor opening into a cavity provided in the interior volume, a wringer being attached or attachable to the bucket within or above the interior volume; the cavity being shaped and configured such that a wringer or a like-shaped element, from a like mop bucket, is locatable in the cavity when the like bucket is stacked on top of the mop bucket.

The present invention provides mop buckets that can be easily stacked, one on top of the other, in a space-efficient manner with the wringer or a like element attached. Equivalent stacking-space-efficiency with prior art mop buckets, such as those described above, is only achievable when the wringer or a like element is removed from the bucket prior to stacking. Allowing mop buckets to be efficiently stacked with the wringer attached is advantageous, in the dual contexts of transportation and display (such as on supermarket or hardware store shelves).

Preferably, the cavity divides the interior volume into two chambers that are not in fluid communication with each other, the wringer being attached or attachable to the bucket to overlie one of the chambers. According to this embodiment, one of the chambers can be used to contain a supply of clean water and detergent, with the other chamber acting as a vessel into which dirty water from the mop can be wrung. This embodiment provides the advantage that the clean mopping water, is not dirtied through the wringing out of a dirty mop.

According to some embodiments, the cavity defines an interior floor region that is downwardly inclined from a horizontal plane passing through the mop bucket, the wringer being attached or attachable to the bucket above the interior floor region, wherein wrung water from the wringer travels along the interior floor region.

Optimally, the cavity defines an interior wall region extending from the interior floor region, the interior wall region extending substantially vertically between the interior floor region and the floor of the mop bucket, the interior wall region, floor and side wall defining one of the chambers.

Typically, the cavity is substantially cylindrical in shape and presents a circular mouth at or near the top of the interior volume , the circular mouth being configured to receive a circular component of a wringer or a like shaped element.

Other cavity shapes are contemplated within the scope of the invention.

According to a second aspect of the present invention there is provided a wringer for use with a mop bucket, the wringer comprising a plurality of circumferentially spaced, flexible spokes that are configured to wring out a mop when pressed therein, each spoke comprising a first limb and a second limb angularly extending from the first limb, the first and second limbs including reinforcing means on one or both sides thereof.

Preferably, an aperture is provided in each spoke at a position at or near the junction of the first and second limb.

According to a third aspect of the present invention there is provided a bucket with a handle attachable thereto, the handle and bucket including cooperating attachment means that are configured to impede rotation of the handle beyond a specified angular position.

Typically, the cooperating attachment means includes one or more attachment assemblies provided on the handle and a stop provided on or associated with the bucket, each attachment assembly being impeded by the stop from being rotated beyond the specified angular position.

The attachment assembly may include a boss extending from the handle and a fin, rudder or the like projecting from the boss.

Typically, the specified angular position is relative to a plane that is substantially perpendicular to the top surface of the bucket. An angular position of around 5 degrees from the perpendicular plane provides an optimal angular traversal path for the handle.

### BRIEF DESCRIPTION OF THE DRAWINGS

An embodiment of the invention will now be further explained and illustrated by reference to the accompanying drawings in which:

FIG. 1 is a perspective view of a mop bucket in accordance with an embodiment of the invention;

FIG. 2 is a perspective view of the mop bucket illustrated in FIG. 1, with the wringer removed;

FIG. 3 is a bottom perspective view of the mop bucket illustrated in FIG. 1

FIG. 4 is an elevation view of the mop bucket illustrated in FIG. 1;

FIG. 4A is an elevation view of the handle illustrated in FIG. 1;

FIGS. 4B and 4C are magnified views showing attachment of the handle to the bucket;

FIGS. 5 and 6, and FIGS. 9 to 11 are various views of the wringer illustrated in FIG. 1;

FIG. 7 is a cross-sectional view of the wringer through the line B-B in FIG. 5;

FIG. 8 is a profile view of one of the wringer spokes illustrated in FIG. 1;

FIG. 12 is a cross-sectional view of the wringer through the line H-H in FIG. 11;

FIG. 13 is a cross-sectional view of the wringer illustrated in FIG. 1, showing a mop wringing operation;

FIG. 14 is a plan view of the bucket illustrated in FIG. 2 with the wringer removed;

FIG. 15 is a plan view of the bucket illustrated in FIG. 1, including the wringer;

FIG. 16 is a bottom plan view of the bucket illustrated in FIG. 2;

FIG. 17 is a bottom perspective view of the bucket illustrated in FIG. 2;

FIG. 18 is a cross-sectional view through the line A-A in FIG. 14;

FIGS. 19 and 20 are respective elevation and end views of two mop buckets in accordance with an embodiment of the invention, stacked one on top of the other with wringers attached to both buckets;

FIG. 21 is a plan view of the top bucket illustrated in FIGS. 19 and 20;

FIG. 22 is a cross-sectional view of the stacked buckets through the line F-F in FIG. 21; and

FIG. 23 is an enlarged view of the circled region shown in FIG. 22.

### DETAILED DESCRIPTION OF THE DRAWINGS

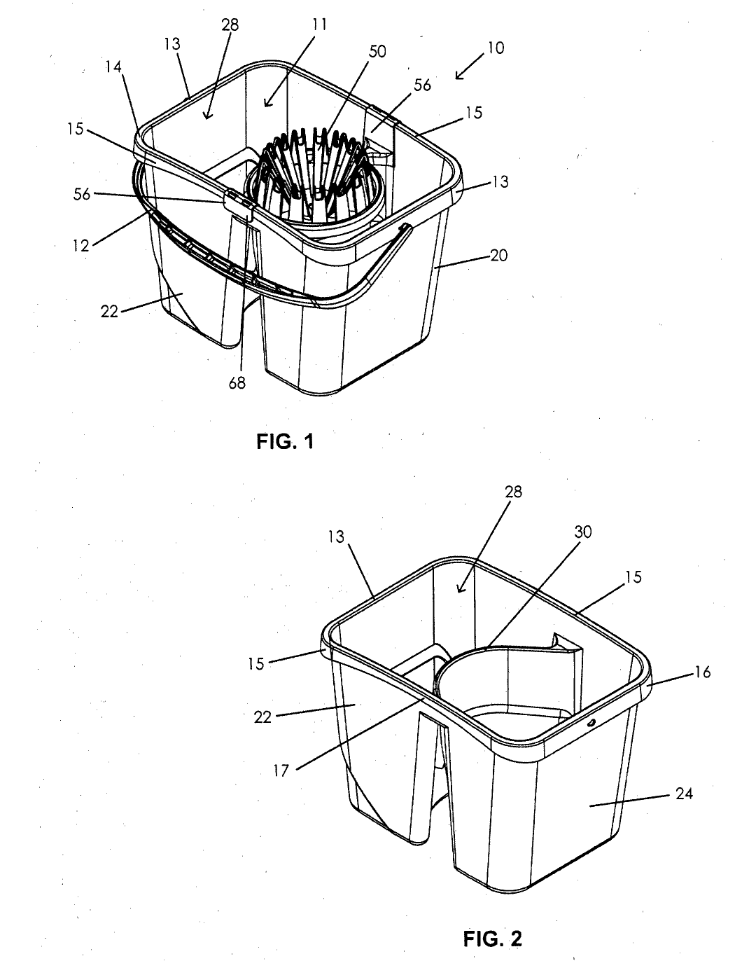

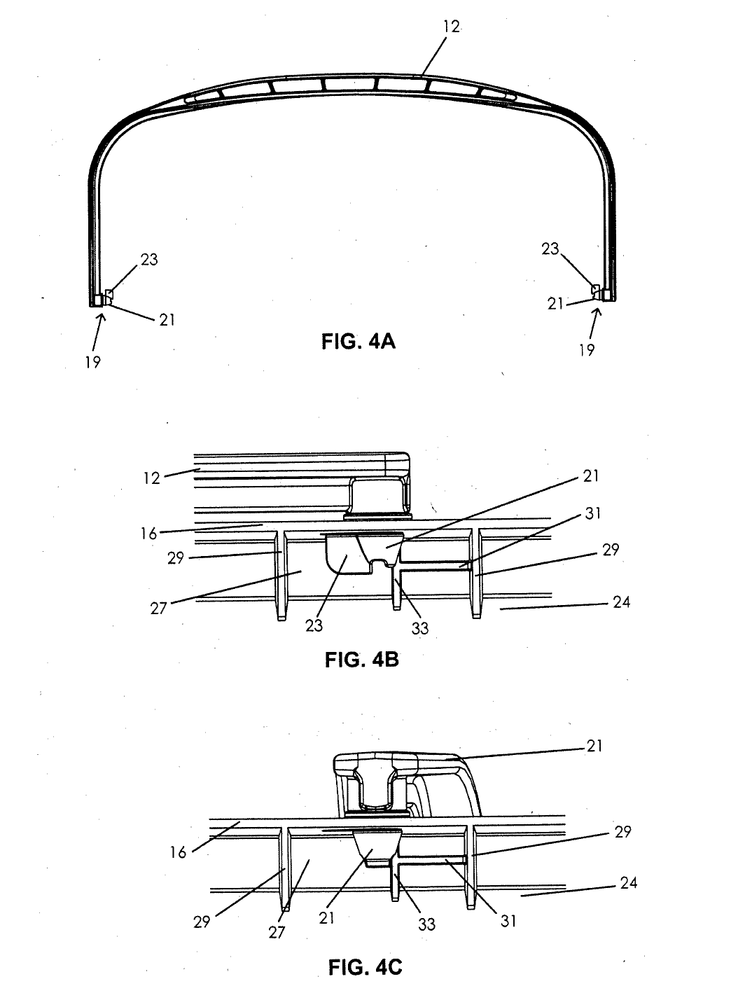

Turning to FIGS. 1 and 4, a mop bucket 10 in accordance with an embodiment of the invention is illustrated. Mop bucket 10 is manufactured from polypropylene.

Mop bucket 10 is composed of a bucket 20 and a wringer 50. The open top 11 of bucket 20 is rectangular, having shorter 13 and longer 15 sides. A rectangular skirt 16 projects downwardly from the rim 14 of bucket 20. The width of skirt 16 is constant along shorter sides 13, but varies along longer sides 15. More specifically, skirt 16 tapers towards a shorter width 17 that is located approximately midway along longer sides 15.

Longitudinal 22 and lateral 24 side walls extend downwardly respectively from longer 13 and shorter 15 sides and terminate in a floor 26. Floor 26, side walls 22 and 24 and open top 11 define an interior volume 28 of bucket 20.

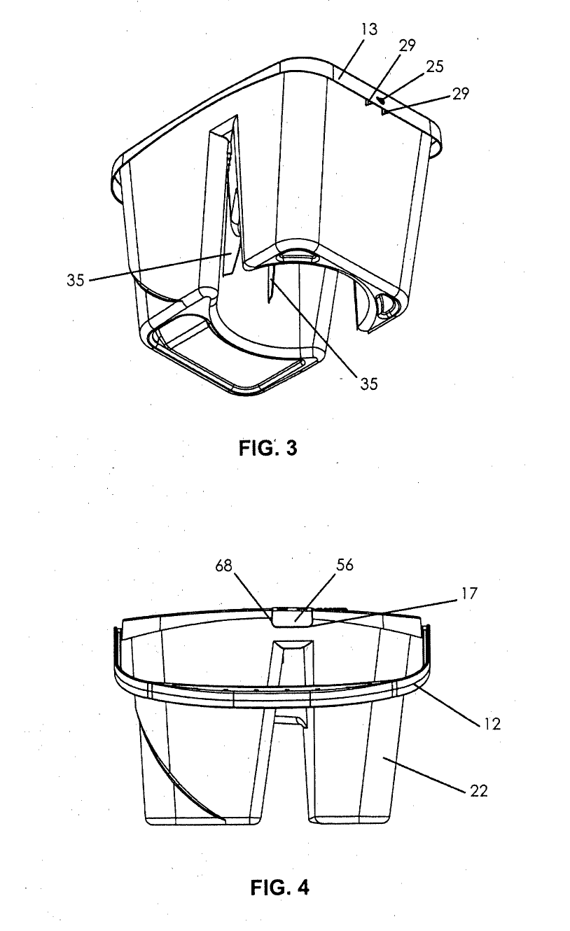

A handle 12 is attached midway along each shorter side 13, and extends the length of longer sides 15. As shown most clearly in FIGS. 3 and 4A, handle 12 is roughly c-shaped and includes an attachment assembly 19 at each of its free ends. Attachment assembly 19 includes an inwardly extending boss 21 and a fin 23 that extends upwardly from boss 21. Attachment assembly 19 snap fits into an aperture 25 formed midway along each shorter side 13.

As illustrated in FIGS. 4B and 4C, aperture 25 opens into an interior 27 that is defined by lateral side wall 24 and rectangular skirt 16. A pair of integrally formed rectangular spacers 29 extend between lateral side wall 24 and rectangular skirt 16. An interposed ceiling member 31 extends from spacer 29 to run parallel to both lateral side wall 24 and rectangular skirt 16. A wall member 33 projects downwardly from ceiling member 31 and attaches to lateral side wall 24.

When handle 12 is inserted into interior 27, it can be rotated into a position adjacent to one longitudinal side wall 22 (shown in FIG. 1). FIG. 4B shows the position of fin 23, when handle 12 is in this position.

Handle can be rotated from its position adjacent to longitudinal side wall 22, but, only as far as a location approximately 5 degrees beyond a plane that is perpendicular to top 11 of bucket 10. During rotation of handle 12, fins 23 are free to rotate about an axis defined by bosses 21 until they come into contact with wall member 33. Rotation beyond this position is prevented or impeded due to the presence of wall member 33, that act as a stop.

When bucket 10 contains water, this ‘anti-tipping’ feature reduces the tendency of bucket 10 to sway from side to side with the movement of the water as the bucket is transported from one location to another. Consequently, the feature also aids in preventing water from spilling from the bucket.

Wringer 50 may be conveniently attached and removed from bucket 20. For example, wringer 50 may be removed for the purpose of cleaning or maintenance, and then reattached to bucket 20 for future use. FIG. 2 shows a convex dividing partition 30, which is visible when wringer 50 is removed from bucket 20 and is attached to the inside of longitudinal side walls 22.

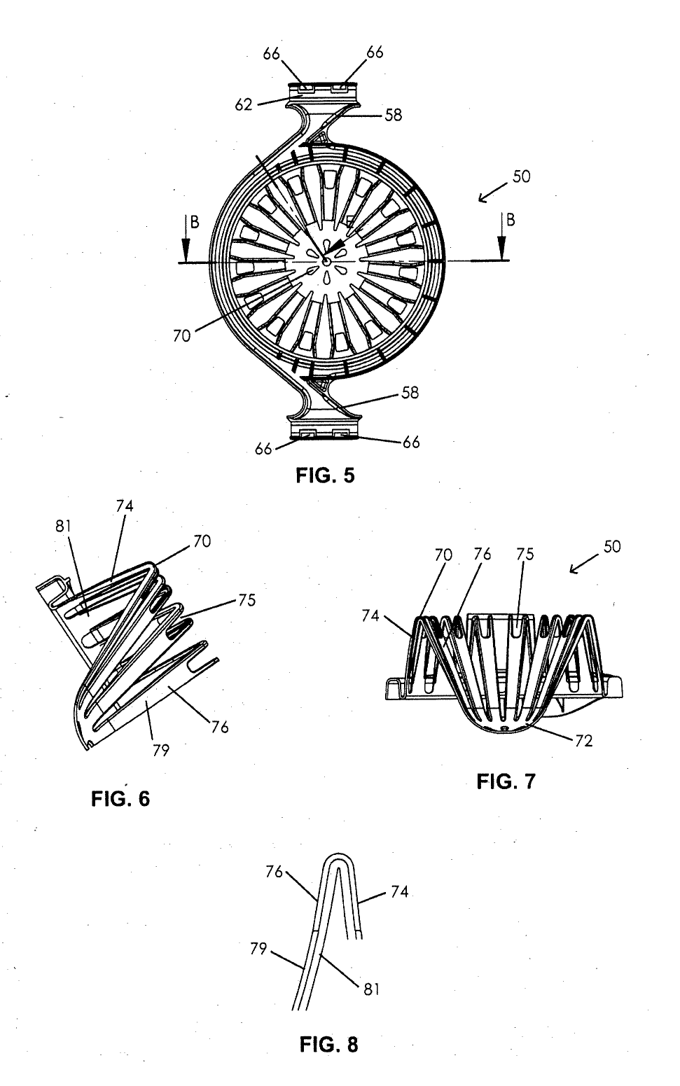

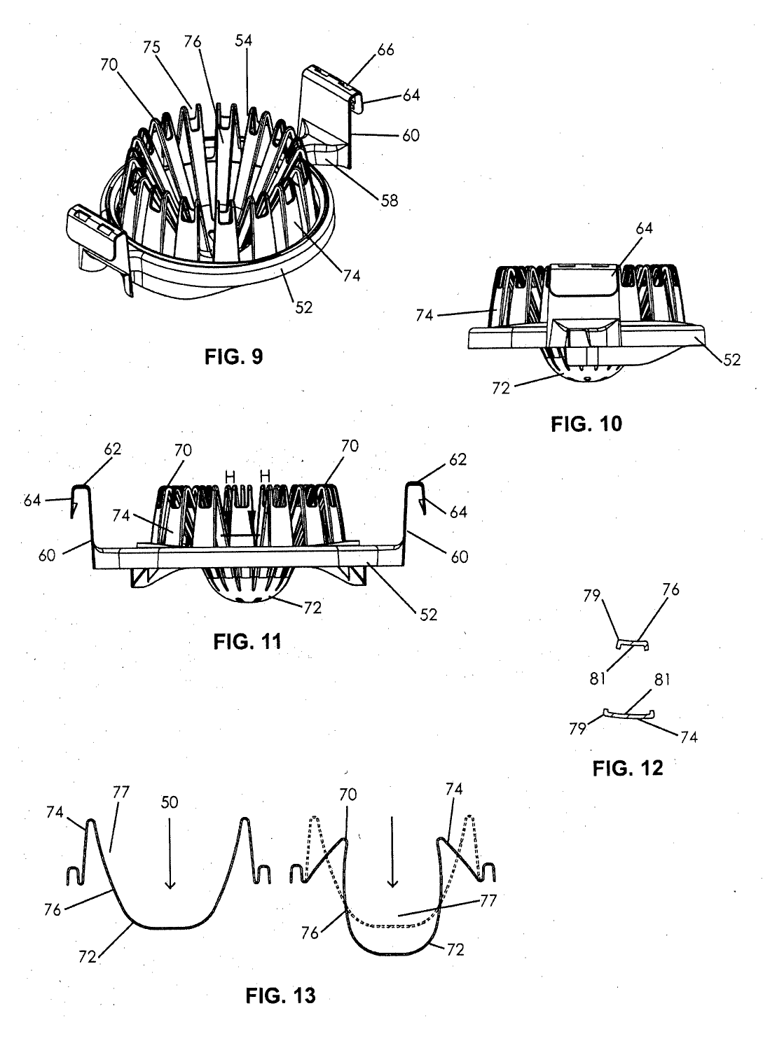

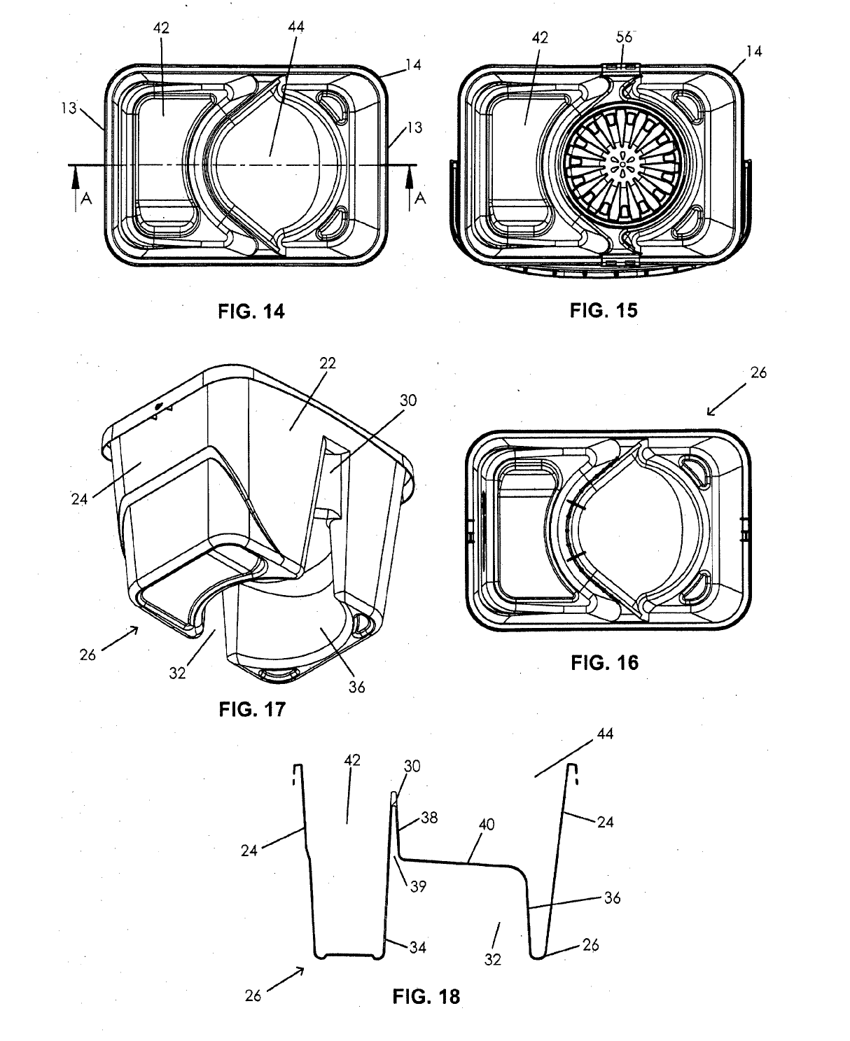

The structure of wringer 50 is most clearly illustrated by reference to FIGS. 5 to 13. As is apparent from those Figures, wringer 50 is composed of an annular holding member 52 which encircles a wringer member 54. A pair of diametrically opposed clips 56 are provided on holding member 52, which are used to removably attach wringer 50 to bucket 20 in the manner described below. Each clip 52 includes a radially extending collar member 58, a vertical wall member 60, a two-part planar bridge member 62 that extends approximately perpendicularly from wall member 60, and a trailing edge member 64 that extends approximately perpendicularly from bridge member 62. Trailing edge member 64 is horizontally spaced from, and lies approximately parallel to, wall member 60. A pair of rectangular apertures 66 are provided in bridge member 62.

Wringer 50 (including clips 56) is made from a resiliently flexible material, such as polypropylene. This allows clips 56 to be easily and securely attached to bucket 20 by snap fitting bridge members 62 over rim 14 approximately midway along longer edges 15. Apertures 66 assist bridge member 62 in flexing over rim 14. When attached in this manner, trailing edge members 64 abut against rectangular skirt 16 and thereby hold wringer 50 securely in place against bucket 20.

As most clearly shown FIG. 4, wringer 50 is attached to bucket 20 at the shorter width 17 portion of skirt 16. In this way, a part 68 of trailing edge member 64 projects beyond the lower edge of skirt 16. Projecting part 68 serves as a means for removing wringer 50 from bucket 20. In particular, a user can easily insert a finger behind projecting part 68 and pull trailing edge member 64 away from skirt 16. Clip 56 can then be simply lifted in an upwards direction free of rim 14.

Wringer member 54 is composed of a series of circumferentially spaced, resiliently-flexible, v-shaped spokes 70 which converge into an integrally formed basket 72. Each spoke 70 includes a first limb 74 that is attached to holding member 52 and extends in an axially upwards and slightly radially inwards direction. A second limb 76 extends from first limb 74 in an axially downwards and radially inwards direction to converge into basket 72. A rectangular section 75 is cut out of either side of the junction of first 74 and second 76 limb. The faces of second limbs 76 and basket 72 define a generally conic shaped throat 77.

As shown in FIGS. 6, 8 and 12, each side of first limb 74 and second limb 76 are strengthened and reinforced by respective continuous ribs 79 and 81 of increased thickness.

As shown in FIG. 13, wringer 50 operates by a user placing a mop (not shown) into basket 72. The mop is then pushed in an axially downwards direction which causes each first limb 74 to bend in a generally radially inwards direction about its line of connection to holding member 52. Second limbs 76 also bend in a generally radially outwards direction about their line of extension from first limb 74. Ribs 79 and 81 provide the required strength for first limbs 74 and second limbs 76 to bend in this manner. The simultaneous bending of first limbs 74 and second limb 76 causes basket 72 (and the mop inserted therein) to move in an axially downwards direction and throat 77 to constrict. This action causes compression of the mop, and fluid to be consequently wrung out of the mop fibres against the spaces between second limbs 76.

A series of tear-drop shaped holes 78 are formed in basket 72 for receiving fluid that is wrung from the ends of the mob fibres.

Turning to FIGS. 3, 17 and 18, it is apparent that floor 26 is not a planar panel, but rather opens into a generally cylindrical cavity 32 that occupies part of interior volume 28 of bucket 20. Cavity 32 is formed between first 34 and second 36 vertically extending interior walls, each having an approximately c-shaped cross section. A shorter interior wall 38 extends from the top of first wall 34 and diverges slightly away from first wall 34, leaving a small-wedge 39 of empty space. An interior floor region 40 extends from the end of short wall 38 and projects in a direction slightly downward of the horizontal before branching perpendicularly into second interior wall 36. A pair of converging de-nesting ribs 35 (the function of which is described in detail below) are provided on first interior wall 34.

It will be apparent that side walls 22 and 24, floor 26 and first interior wall 34 define a first chamber 42 in interior volume 28. Similarly, shorter wall 38, interior floor region 40, second interior wall 36, floor 26 and side walls 22 and 24, define a second chamber 44 in interior volume 28. Interior walls 34 and 38 provide fluid separation between the two chambers 42 and 44.

In use, first chamber 42 is used to contain a supply of a clean water and detergent mixture for mopping purposes. Second chamber 44 is located below the point of connection of wringer 50. Conveniently, fluid which is wrung from a mop (which typically contains dirt that is collected from the surface being mopped) drains onto inclined interior floor region 40 and runs down into the part of second chamber 44 defined between second interior wall 36 and side walls 22 and 24. In this way, dirty water from the mop is kept separate from the supply of clean water and detergent housed in first chamber 42.

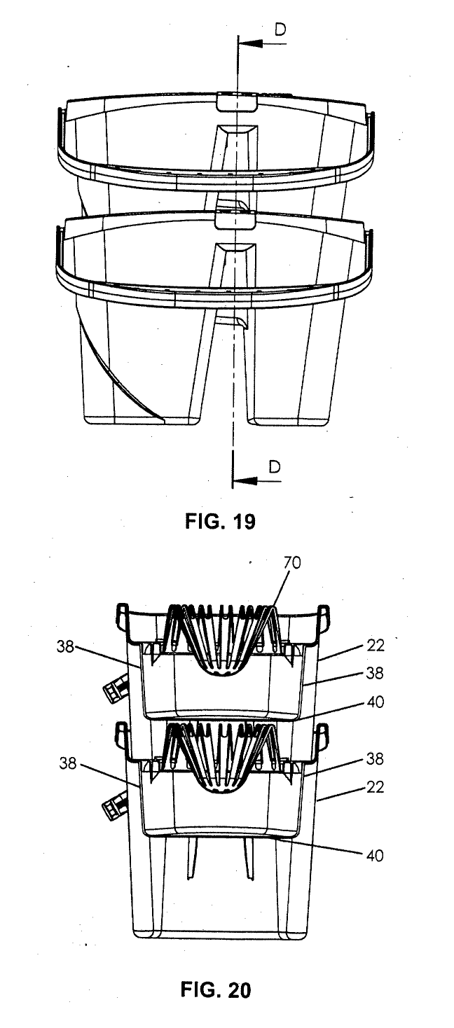

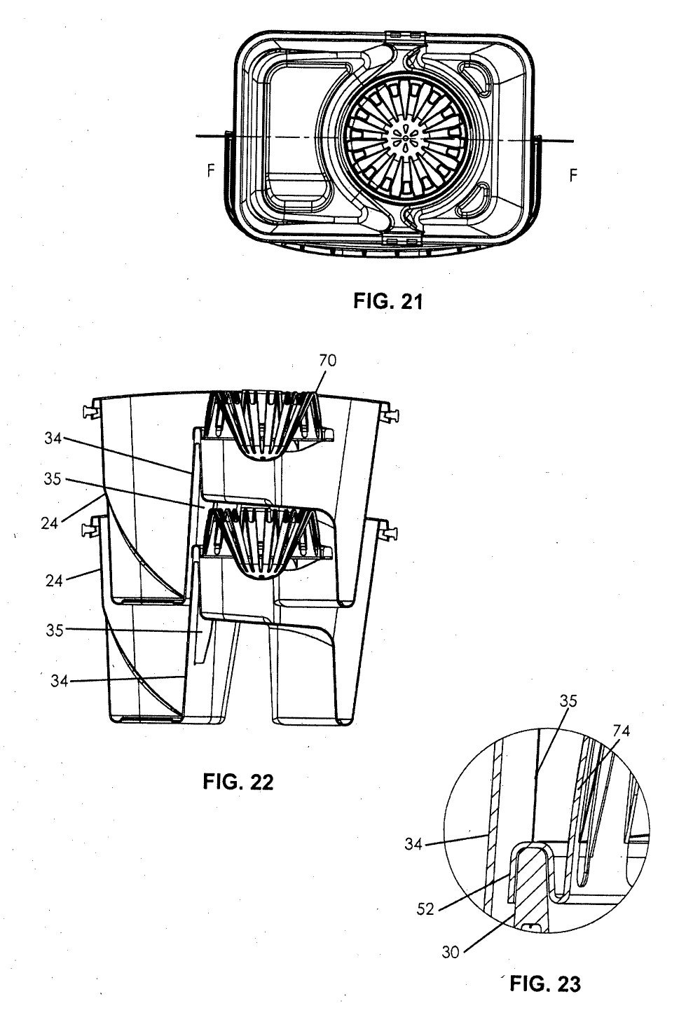

As well as providing a benefit in terms of dividing the bucket's interior volume into separate compartments, the presence of cavity 32 also significantly improves the stacking efficiency of mop bucket 10. As most clearly illustrated in FIGS. 19 to 23, mop bucket 10 can be conveniently stacked, one on top of the other, by inserting the floor 26 of one bucket into the open mouth 11 of another bucket. The two chambers 42 and 44 project downwardly into the lower bucket's interior volume, with the cavity 32 of the upper bucket surrounding the wringer 50 of the lower bucket. In this way, one bucket can be nested into another to the extent of almost half its height.

As shown most clearly in FIGS. 22 and 23, when stacked, ribs 35 from an upper bucket come to rest on holding member 52 of a lower bucket. This ensures that the upper bucket does not travel too deeply into the interior of the lower bucket so that the buckets can be easily de-nested when required.

It is to be understood that, throughout the description and claims of the specification, the word “comprise” and variations of the word, such as “comprising” and “comprises”, is not intended to exclude other additives, components, integers or steps.

Modifications and improvements to the invention will be readily apparent to those skilled in the art. Such modifications and improvements are intended to be within the scope of this invention.

1-12. (canceled)

13. A mop bucket comprising a floor and side walls projecting upwardly from the floor, the floor and side walls defining an interior volume, the floor opening into a cavity provided in the interior volume, a wringer being attached or attachable to the bucket within or above the interior volume, the cavity occupying a sufficient part of the interior volume, and being shaped and configured such that a wringer or a like-shaped element, from a like mop bucket, is locatable in the cavity when the like bucket is stacked on top of the mop bucket.

14. A mop bucket according to claim 13, wherein the cavity divides the interior volume into two chambers that are not in fluid communication with each other, the wringer being attached or attachable to the bucket to overlie one of the chambers.

15. A mop bucket according to claim 13, wherein the cavity defines an interior floor region that is downwardly inclined from a horizontal plane passing through the mop bucket, the wringer being attached or attachable to the bucket above the interior floor region, wherein wrung water from the wringer travels along the interior floor region.

16. A mop bucket according to claim 14, wherein the cavity defines an interior floor region that is downwardly inclined from a horizontal plane passing through the mop bucket, the wringer being attached or attachable to the bucket above the interior floor region, wherein wrung water from the wringer travels along the interior floor region.

17. A mop bucket according to claim 15, wherein the cavity defines an interior wall region extending from the interior floor region, the interior wall region extending substantially vertically between the interior floor region and the floor of the mop bucket, the interior wall region, floor and side wall defining one of the chambers.

18. A mop bucket according to claim 16, wherein the cavity defines an interior wall region extending from the interior floor region, the interior wall region extending substantially vertically between the interior floor region and the floor of the mop bucket, the interior wall region, floor and side wall defining one of the chambers.

19. A mop bucket according to claim 13, wherein the cavity is substantially cylindrical in shape and presents a circular mouth at or near the top of the interior volume, the circular mouth being configured to receive a circular component of a wringer or a like shaped element.

20. A mop bucket according to claim 14, wherein the cavity is substantially cylindrical in shape and presents a circular mouth at or near the top of the interior volume, the circular mouth being configured to receive a circular component of a wringer or a like shaped element.

21. A mop bucket according to claim 15, wherein the cavity is substantially cylindrical in shape and presents a circular mouth at or near the top of the interior volume, the circular mouth being configured to receive a circular component of a wringer or a like shaped element.

22. A mop bucket according to claim 16, wherein the cavity is substantially cylindrical in shape and presents a circular mouth at or near the top of the interior volume, the circular mouth being configured to receive a circular component of a wringer or a like shaped element.

23. A mop bucket according to claim 17, wherein the cavity is substantially cylindrical in shape and presents a circular mouth at or near the top of the interior volume, the circular mouth being configured to receive a circular component of a wringer or a like shaped element.

24. A mop bucket according to claim 18 wherein the cavity is substantially cylindrical in shape and presents a circular mouth at or near the top of the interior volume, the circular mouth being configured to receive a circular component of a wringer or a like shaped element.

25. A wringer for use with a mop bucket, the wringer comprising a plurality of circumferentially spaced, flexible spokes that are configured to wring out a mop when pressed therein, each spoke comprising a first limb and a second limb angularly extending from the first limb, the first and second limbs including reinforcing means on one or both sides thereof.

26. A wringer according to claim 25, wherein an aperture is provided in each spoke at a position at or near the junction of the first and second limb.

27. A bucket with a handle attachable thereto, the handle and bucket including cooperating attachment means that are configured to impede rotation of the handle beyond a specified angular position.

28. A bucket according to claim 27, wherein the cooperating attachment means includes one or more attachment assemblies provided on the handle and a stop provided on or associated with the bucket, each attachment assembly being impeded by the stop from being rotated beyond the specified angular position.

29. A bucket according to claim 28, wherein the attachment assembly includes a boss extending from the handle, and a fin, rudder or the like projecting from the boss.

30. A bucket according to claim 27, wherein the specified angular position is relative to a plane that is substantially perpendicular to the top surface of the bucket.

31. A bucket according to claim 28, wherein the specified angular position is relative to a plane that is substantially perpendicular to the top surface of the bucket.

32. A bucket according to claim 30, wherein the angular position is around 5 degrees from the perpendicular plane.
